(19) United States
(12) Patent Application Publication
(10) Pub. No.: US 2008/0098959 A1
(43) Pub. Date: May 1, 2008

(54) Pet waste removal apparatus and method

(76) Inventor: Dennis J. Iarrusso, Pittsburgh, PA (US)

Correspondence Address: MEYER UNKOVIC & SCOTT LLP, 1300 OLIVER BUILDING, PITTSBURGH, PA, 15222, US

(21) Appl. No.: 11/977,075

(22) Filed: Oct. 23, 2007

Related U.S. Application Data
(60) Provisional application No. 60/854,272, filed on Oct. 25, 2006.

(51) Int. Cl. A01K 29/00

(52) U.S. Cl. 119/161

(57) ABSTRACT

An apparatus and method for collecting animal excrement that involves the use of an excrement collecting tool that is comprised of a pole; an optional handle attached to the upper portion of said pole; at least two outwardly extending arms attached to the bottom of said pole that are capable of closing inwardly toward each other; a triggering mechanism attached to the handle or the top of the pole and to the arms that, when activated, causes the arms to close; and a removable bag that attaches around the arms to provide an excrement receiving area and that collapses to encompass received excrement when the triggering mechanism is activated. Optionally, the pole can have telescoping sections that allow for adjustment of the length of the pole. Other options allow the arms to be folded up against the pole and otherwise adjusted in size. In use, the excrement collecting apparatus is placed below an animal when it is defecating and, after waste is received, the bag is removed for disposal.

### PRIORITY

This application hereby claims priority to provisional patent application Ser. No. 60/854,272, filed on Oct. 25, 2006.

### FIELD OF THE INVENTION

The invention relates generally to pet hygiene management and more particularly to an animal excrement collecting device that provides the user with a convenient and sanitary method of collecting and disposing of pet waste.

### BACKGROUND OF THE INVENTION

The waste left by domestic animals and pets is unsightly, and more importantly, presents a health hazard. As such, many municipalities and governing bodies, such as condominium and housing associations, have ordinances and rules concerning the cleaning up of pet excrements. Pet owners often face large fines if they fail to collect and properly dispose of pet waste while walking their pets in public spaces. In other instances, a pet owner is frequently faced with the problem that an owner's pet shares the same outdoor space used by the owner. In both of these situations, where the owner or other individuals will come in contact with the waste, it is desirable to collect and appropriately dispose of the same to prevent possible human contact.

While walking a pet, the owner usually carries plastic bag to retrieve the pet's waste. Often, the owner must hand-carry the used plastic bag during the remainder of the walk, which can be cumbersome and foul smelling.

Prior art devices have presented certain problems that have limited their usefulness to pet owners. While various tools have been devised for catching and discarding pet waste, these tools have not been of the variety that allows for the collection of pet waste in a simple and easy-to-use fashion. Most devices are often large and cumbersome and may cause embarrassment and discomfort to those persons who use such devices in public areas.

While, some references have attempted to solve this ongoing problem by various methods, none have fully eliminated the problem.

U.S. Pat. No. 7,090,268 to Borman, U.S. Pat. No. 6,039,370 to Dooley, and U.S. Pat. No. 5,971,452 to Marymor, for example, all disclose a pet excrement collection device. One disadvantage of these inventions is that they are all bulky and cumbersome for the pet owner to use while walking his or her pet. The size of these devices also makes them difficult to store. Additionally, the devices do not come with their own custom bag that attaches firmly to the device, as is disclosed in the present invention. Moreover, the owner must physically close the bag after the pet has defecated. In doing so, the owner must come in close contact with the contaminated and foul smelling waste.

The present invention overcomes the disadvantages of the related references as discussed below.

### SUMMARY OF THE INVENTION

A primary object of the present invention is to provide a convenient and sanitary method of entrapment and disposal of pet waste.

Another object of the present invention is to provide an elongated pole with a removable bag holder for supporting a custom disposable bag.

Yet another object of the present invention is to provide an opening and closing mechanism that attaches to the elongated pole, allowing the user to open and close the bag containing the waste.

Yet another object of the present invention is to provide an elongated pole capable of telescopically collapsing and/or folding to allow for a less cumbersome device while being carried.

Yet another object of the present invention is to provide a custom bag which is easy to use and remove with the present invention.

Yet another object of the present invention is to provide a hook or clasp on the handle to enable the user to attach the invention on the user's belt.

To the accomplishment of the above and related objects, this invention may be embodied in the form illustrated in the accompanying drawings.

### BRIEF DESCRIPTION OF THE DRAWINGS AND FIGURES

FIG. 1 is a perspective view of the pet waste removal apparatus of the present invention showing a custom bag attached to the L-shaped members of the invention.

FIG. 2 is a side view of the pet waste removal apparatus of the present invention.

FIG. 3 is an enlarged perspective view of the present invention, showing the handle and trigger mechanism of the pet waste and removal apparatus.

FIG. 4 is an enlarged perspective view of the present invention, showing the L-shaped members.

FIG. 5 is a perspective view of the pet waste removal apparatus showing the invention in its collapsed and/or folded state.

### DETAILED DESCRIPTION OF THE INVENTION

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated apparatus and method, and such further applications of the principles of the invention illustrated herein, as would normally occur to persons skilled in the art to which the invention relates.

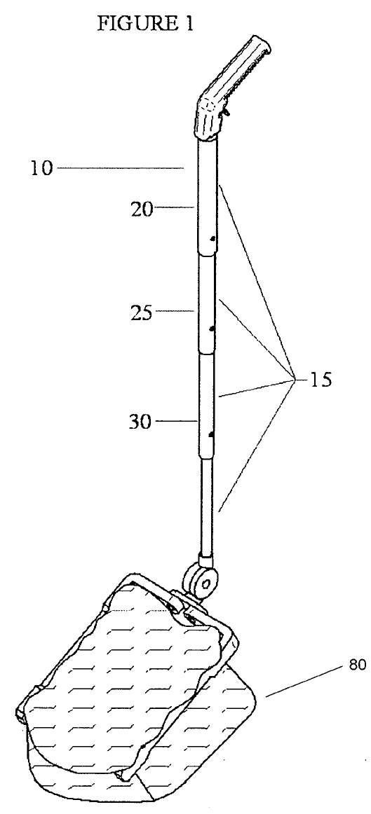

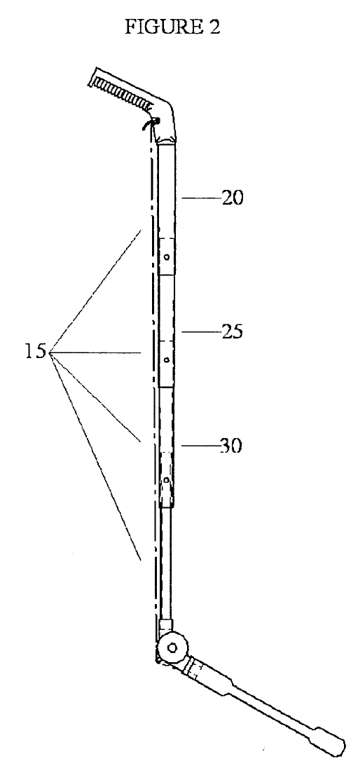

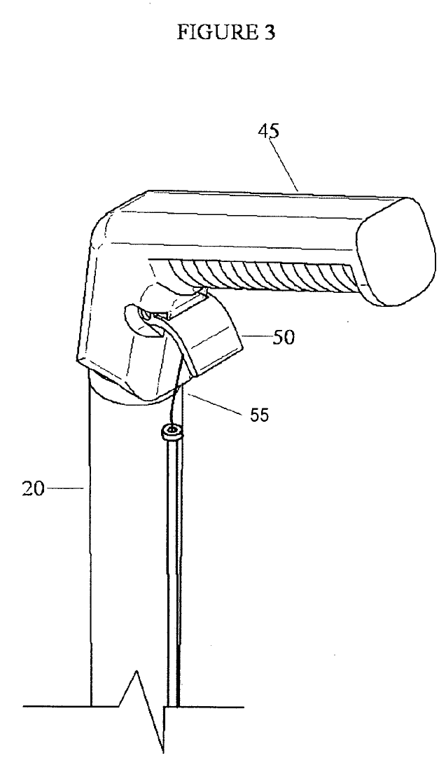

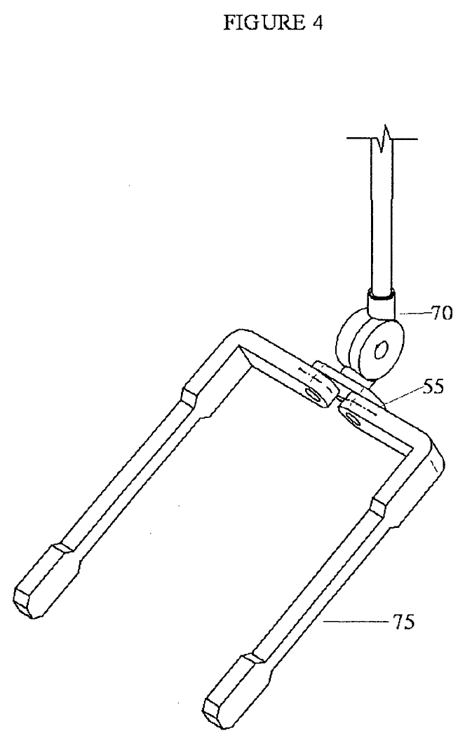

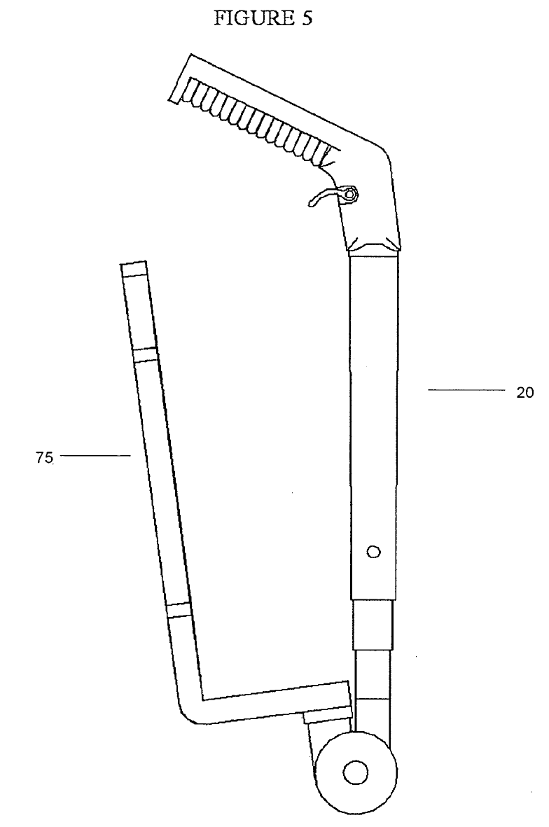

Referring now to FIGS. 1-5, the pet waste removal apparatus 10 has an elongated pole 15 consisting of a first segment 20, a second segment 25, and a third segment 30. The first segment 20 can slide over and/or within the second segment 25 in a telescopic matter. Similarly, the second segment 25 can slide over and/or within the third segment 30 in a telescopic matter. The elongated pole 15 can have any number of segments and still be within the scope of the invention. The elongated pole 15 can also optionally fold over itself instead of sliding over and/or within another segment. In this alternative embodiment, a hinge can be situated between any one of the segments allowing the partially collapsed pole to fold onto the remaining part of the invention.

The first segment 20 is preferably attached to a handle 45 that extends away from the first segment 20 at a preferred angle.

The third segment 30 is preferably attached to a swivel connection 70. A pair of L-shaped members 75 pivotally attach to and extend outwardly from the swivel connection 70.

The L-shaped members 75 are optionally pivotably attached to the elongated pole 15 to allow for adjustment depending on the size of the animal. The L-shaped members 75 can also be attached to the elongated pole 15 by means of a hinge such that the handle portions can fold over the L-shaped members for storage or carrying.

The handle 45 contains a trigger 50 with a cable 55 attached thereto. The cable 55 is also attached to the L-shaped members 75. In the preferred embodiment, the trigger 50, when squeezed or depressed, pulls or pushes on the cable 55, which opens or closes the L-shaped members 75. In an alternative embodiment, a rod connects the trigger 50 to the L-shaped members 75. The trigger 50, when squeezed or depressed, pulls or pushes the rod forward or rearward to open or close the L-shaped members 75.

A custom plastic bag 80 having openings to allow the bag to easily slide onto and off of the L-shaped members 75.

In a preferred embodiment, a hook is optionally attached to one of the L-shaped members 75, the elongated pole 15 or the handle 45 for purposes of carrying the invention on the user's belt or clothing. In other embodiments, a clasp or any other hooking mechanism known to those skilled in the art may be used.

The pair of L-shaped members 75 can open and close in a scissor-like fashion and optionally, only one of the L-shaped members 75 can pivot, slide open or close.

A user brings the present invention with him or her while walking his or her pet. Prior to walking the pet, the user places the plastic bag 80 on the pair of L-shaped members 75. When the pet squats to defecate, the user extends the elongated pole 15 and then by using the handle 45, positions the pet waste removal apparatus 10 under the area wherein the pet is defecating to catch the waste. After the pet has finished defecating, the user then pushes or pulls the trigger 50 to close the L-shaped members 75 and slides the bag 80 (containing the waste) from the L-shaped members 75 and disposes of it. The user then collapses the elongated pole 15 of the pet waste removal apparatus 10 and reattaches the device to his or her belt by means of a hook or other attachment means. Alternatively, the bag can be left on the L-shaped members 75 until the user returns from his or her walk.

I claim:

1. An apparatus device for collecting animal excrement, said apparatus comprising:
a pole;
a handle attached to the upper portion of said pole;
at least two outwardly extending arms attached to the bottom of said pole, with at least one of said arms capable of closing inwardly toward the other at least one arm;
a triggering mechanism attached to said handle and said at least one closing arm, wherein activation of said trigger mechanism causes said at least one closing arm to close; and
a removable bag that attaches around said outwardly extending arms to provide an excrement receiving area and that collapses to encompass received excrement when said mechanism is activated.

2. The apparatus according to claim 1 further comprising an attachment device, attached to said pole, which permits the apparatus to be attached to the belt or other clothing of a user of the apparatus.

3. The apparatus according to claim 1 further comprising an attachment device, attached to said handle, which permits the apparatus to be attached to the belt or other clothing of a user of the apparatus.

4. The apparatus according to claim 1 further comprising an attachment device, attached to one of said outwardly extending arms, which permits the apparatus to be attached to the belt or other clothing of a user of the apparatus.

5. The apparatus according to claim 1, wherein all of said at least two outwardly extending arms close inwardly in response to activation of said trigger mechanism.

6. The apparatus according to claim 1, wherein said outwardly extending arms are hingeably attached to said pole such that said, when not in use, can be folded upward against said pole.

7. The apparatus according to claim 1, wherein said outwardly extending arms are pivotably attached to said pole such that the open position of said arms and the size of said excrement receiving area can be adjusted.

8. The apparatus according to claim 1, wherein said pole is comprised of two or more telescoping sections such that the length of said pole can be adjusted.

9. The apparatus according to claim 5, wherein said arms close in a scissors-like manner.

10. An apparatus for collecting animal excrement, said apparatus comprising:
a pole;
at least two outwardly extending arms attached to the bottom of said pole, with at least one of said arms capable of closing inwardly toward the other at least one arm;
a triggering mechanism attached to the top of said pole and said at least one closing arm, wherein activation of said trigger mechanism causes said at least one closing arm to close; and
a removable bag that attaches around said outwardly extending arms to provide an excrement receiving area and that collapses to encompass received excrement when said mechanism is activated.

11. A method for collecting animal excrement, said method comprising:
Placing an excrement collecting apparatus under a defecating animal, said apparatus comprising:
a pole;
at least two outwardly extending arms attached to the bottom of said pole, with at least one of said arms capable of closing inwardly toward the other at least one arm;
a triggering mechanism attached to the top of said pole and said at least one closing arm, wherein activation of said trigger mechanism causes said at least one closing arm to close; and
a removable bag that attaches around said outwardly extending arms to provide an excrement receiving area and that collapses to encompass received excrement when said mechanism is activated; and
removing and disposing of said bag along with the received excrement.
